(19) United States
(12) Patent Application Publication
(10) Pub. No.: US 2026/0144278 A1
(43) Pub. Date: May 28, 2026

(54) METHODS AND SYSTEMS FOR STERILIZING NATURAL PRODUCTS

(71) Applicant: Material Futures Inc., Toronto (CA)

(72) Inventors: Yilan LIU, Waterloo (CA); Jinjin CHEN, Waterloo (CA)

(73) Assignee: Material Futures Inc., Toronto (CA)

(21) Appl. No.: 18/962,955

(22) Filed: Nov. 27, 2024

(51) Int. Cl. A23L 5/20

(52) U.S. Cl. CPC A23L 5/276

(57) ABSTRACT

Provided herein is a system to prepare a natural product. The system can include a vessel to include a natural product including a concentration of an acid. The system can include a first sensor to determine the natural product that includes the concentration of the acid has a first pH within a range of 0 to 3. The system can include a fluid transfer tool to add a base to the natural product that includes the concentration of the acid. The system can include at least one of the first sensor or a second sensor to determine the natural product that includes the concentration of the acid and that includes the concentration of the base has a second pH within a range of 4 to 9.

### BACKGROUND

Food spoiling occurs when microorganisms, such as bacteria, mold, and yeast, break down the food's nutrients, causing it to decay. This process is accelerated by improper storage, temperature fluctuations, and exposure to air, leading to changes in texture, color, and smell. Spoiled food can pose health risks as harmful pathogens can grow.

### SUMMARY

Systems and methods described herein relate to processing liquid natural products to eliminate, prevent, or reduce susceptibility to spoilage. Spoilage is a pervasive issue affecting a range of liquid natural products. These natural products include liquid primary food products, such as milk juices, and dairy derivatives, and liquid agricultural byproducts, including milk permeate, whey, and crop residues. These products are particularly vulnerable to microbial contamination and enzymatic degradation, which can lead to significant economic losses and food waste. Current preservation methods, such as drying or pasteurization, are energy-intensive and may degrade the nutritional or functional properties of the products. Disclosed herein are systems and methods for extending the shelf life of natural products through chemical treatment that sterilize and stabilize these materials efficiently and sustainably.

The systems and methods described herein provide a scalable and efficient approach to sterilizing and preserving food and agricultural products. The disclosed processes apply to a wide range of natural products, including primary food products such as milk, juices, and dairy derivatives, as well as agricultural byproducts like whey and crop residues. By employing controlled pH adjustments using acids and bases, the processes achieve microbial reductions ofup to 100%, significantly extending the shelf life of these materials. The treated products are stable for extended periods under various storage conditions, retain their nutritional value, and are suitable for use in diverse industries, including food, beverages, animal feed, microbial cultures, and biomanufacturing.

At least one aspect is directed to a system to prepare natural product. The system can include a vessel to include a natural product including a concentration of an acid. The system can include a first sensor to determine the natural product that includes the concentration of the acid has a first pH within a range of 0 to 3. The system can include a fluid transfer tool to add a base to the natural product that includes the concentration of the acid. The system can include at least one of the first sensor or a second sensor to determine the natural product that includes the concentration of the acid and that includes the concentration of the base has a second pH within a range of 4 to 9.

At least one aspect is directed to a method of preparing natural product. The method can include adding an acid to a natural product to create a sterilized natural product. The method can include detecting that the sterilized natural product that includes the acid has a first pH within a range of 0 to 3. The method can include adding a base to the sterilized natural product that includes the acid to create a modified sterilized natural product. The method can include determining that the natural product that includes the acid and that includes the base has a second pH within a range of 4 to 9. The method can include providing the modified sterilized natural product as an ingredient of at least one of a food product, a beverage, animal feed, or as a nutrient for a microbial culture.

At least one aspect is directed to a modified sterilized natural product prepared by a method comprising adding an acid to a natural product to create a sterilized natural product. The method can include detecting that the sterilized natural product that includes the acid has a first pH within a range of 0 to 3. The method can include adding a base to the sterilized natural product that includes the acid to create a modified sterilized natural product. The method can include determining that the natural product that includes the acid and that includes the base has a second pH within a range of 4 to 9.

At least one aspect is directed to a natural product including an aqueous salt comprising ammonium phosphate, calcium phosphate, sodium phosphate, or a combination of any two or more thereof.

At least one aspect is directed to a kit comprising an acid to add to a natural product to create a sterilized natural product and a base to add to the sterilized natural product to create a modified sterilized natural product. The kit can include a vessel to include the natural product including a concentration of the acid. The kit can include a first sensor to determine the natural product that includes the concentration of the acid has a first pH within a range of 0 to 3. The kit can include a fluid transfer tool to add the base to the natural product that includes the concentration of the acid. The kit can include at least one of the first sensor or a second sensor to determine the natural product that includes the concentration of the acid and that includes the concentration of the base has a second pH within a range of 4 to 9.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 depicts an example illustration of a system for preparing a natural product.

FIG. 2 depicts another example illustration of a system for preparing a natural product.

FIG. 3 depicts a flow diagram of an example method of preparing a natural product.

FIG. 4 is a graph of average OD₆₀₀ of WT E. coli Nissle 1917 carrying pTrc99a-EYIB (ECN-EYIB) bacteria cultured in different media.

FIG. 5 is a graph of average Dm₄₅₃ of ECN-EYIB bacteria cultured in different media.

### DETAILED DESCRIPTION

Following below are more detailed descriptions of various concepts related to, and implementations of systems and methods for preparing a natural product to reduce or remove susceptibility to spoilage. The various concepts introduced above and discussed in greater detail below can be implemented in any of numerous ways.

Natural products including agricultural products as well as non-cultivated and non-farmed products are useful in a wide range of industries. For example, natural products can be useful in food and beverage for human consumption, animal feed, microbial culture (e.g., biomanufacturing), cosmetics and personal care, textiles. Biomanufacturing may be used to produce biofuels, biopesticides, biomaterials (e.g., plastics, fibers), and pharmaceuticals.

Natural products include agricultural products generated during the processing of crops, livestock, and dairy products, can offer a wealth of valuable resources for various industries, including animal feed, food and beverage products for consumption by humans, and microbial culture nutrients. For example, the agricultural product can be an agricultural byproduct. Using these byproducts not only helps reduce waste but also creates a more sustainable circular economy in the agricultural sector.

For example, milk permeate, traditionally viewed as a waste product or animal feed, can be used in producing value-added products. It is currently utilized in food products including baked goods, meats, and soups, as a sucrose replacer, and as a sodium replacer. Milk permeate can also be fermented to produce bioethanol or other chemicals, or dried and sold as a cost-effective ingredient for animal feed.

The potential of natural products is often constrained by their susceptibility to spoilage. The rapid degradation of organic material, coupled with pathogen growth, is a major challenge, especially for liquid natural products like liquid dairy products (e.g., byproducts like milk permeate), crop residues, and glycerin, which are perishable and can spoil quickly due to microbial growth or enzymatic breakdown. To make the most of these materials, they often need to be used or processed into stable forms within a short window of time. For example, agricultural residues can be dried to extend their shelf life for use in various industries. However, these processes face scalability challenges, primarily due to the high energy costs associated with drying and processing, and the underutilization of its nutrient composition.

Disclosed herein are systems and methods of preparing natural products. The systems and methods of preparing natural products can eliminate, reduce, or prevent susceptibility to spoilage, thereby extending the shelf life of the natural products without the high energy costs of conventional preservation methods like drying or pasteurizing. By reducing susceptibility to spoilage, the systems and methods can increase the utilization of natural products, reduce waste, and promote a more sustainable circular economy. Preparation can include chemical treatment of the natural products to form modified natural products. The modified natural products can be sterilized forms of the natural products. Sterilizing the natural products can include destroying bacteria. For example sterilizing the natural product can include destroying 90% to 100% of the bacteria (e.g., 91%, 92%, 93%, 94%, 95%, 96%, 97%, 98%, 99%, 99.5%, 99.9%, or 100%). Example bacteria that can be destroyed can include coliforms and clostridium tyrobutyricum.

By preparing the natural products as disclosed herein, the natural products can be further processed without time constraints. For example, the natural products can be further processed to demineralize the natural products. For example, the natural products can be further processed to extract nutrients. Without time constraints, processing can allow for longer processing times, more efficient logistics, batch sizing, efficient transportation, prevent or reduce waste (e.g., due to unexpected circumstances like inclement weather), and avoid or reduce the use of traditional equipment (e.g., pasteurization and reverse osmosis).

The systems and methods of preparing natural products disclosed herein include a chemical treatment of the natural products. The chemical treatment of the natural product can extend the shelf life of the natural product. The chemical treatment can include adding an acid to the natural product to reduce the pH of the natural product to a pH that is low enough to substantially reduce or kill all harmful pathogens in the natural product. The acidity of the liquid can destroy microbial cell walls and/or inhibit enzyme activity. The acid-treated natural product can be stable at temperatures of 4° C. to about 40° C. for 1 hour to 35 years without spoilage. The chemical treatment can include adding a base to the acid-treated natural product to increase the pH of the acid-treated natural product. For example, the base can be added to neutralize the acid-treated natural product so that the acid-treated natural product is at a pH suitable for use in an industry, including as an ingredient in an animal feed, a food or beverage product for consumption by humans, or a microbial culture nutrient. The natural product, once treated with the acid and the base, includes a salt derived from the acid and the base. The salt can enhance stability of the natural product and/or provide nutrients for use in an industry as disclosed herein.

The systems and methods disclosed herein include systems and methods for preserving both primary food products and secondary agricultural substrates. For example, untreated milk and juice can be stabilized through the described chemical treatment, enabling extended storage without the need for refrigeration or drying. The process involves adding an acid, such as phosphoric acid, to lower the pH to a sterilizing range (e.g., a pH of 0 to 3) and subsequently neutralizing the product with a base, such as ammonium hydroxide, to prepare it for its intended application. The resulting salts formed during this process not only contribute to the nutritional value of the product but also expand its functionality in downstream applications.

The systems and methods disclosed herein are adaptable for use in food and beverage production, dairy processing, animal nutrition, and industrial biomanufacturing, offering a versatile solution for both high-value food products and waste-derived solutions. For example, milk and milk permeate treated through this process remain microbiologically stable for extended periods and can be used directly or as an input for further processing.

The systems and methods disclosed herein can be used to stabilize a variety of liquid natural products, including but not limited to dairy products (e.g., milk, whey, permeate), plant-based liquids (e.g., fruit juices, vegetable extracts), and agricultural byproducts (e.g., glycerin, crop residues). These stabilized natural products are suitable for use in food production, biomanufacturing, and other industrial applications.

Unlike conventional methods such as drying or pasteurization, which often require significant energy and may degrade the nutritional profile of the substrate, the systems and methods disclosed herein provide a low-energy, scalable way to maintain substrate integrity while extending shelf life.

The systems and methods disclosed herein are useful for a variety of applications. For example, the systems and methods disclosed herein are useful for long-term storage of perishable liquids in remote locations, extending the export potential of fresh juices, and stabilizing aqueous solutions for microbial fermentation and biomanufacturing. The systems and methods disclosed herein are also useful for treating a waste stream for environmental discharge so that the waste stream can be discharged in accordance with environmental regulations.

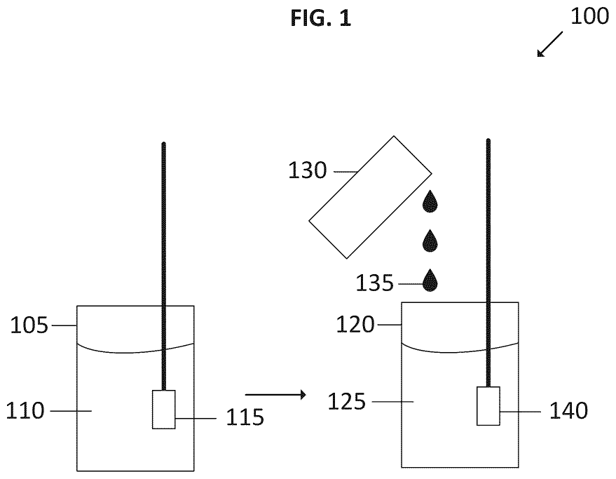

FIG. 1, among others, depicts a system 100. The system 100 can be a system for preparing a natural product. The system 100 can modify the natural product. The system 100 can prepare agricultural products to reduce or prevent susceptibility to spoilage, thereby extending the shelf life of the agricultural products. The system 100 can chemically treat the natural products to form modified natural products. The modified natural products can be sterilized forms of the natural products. The system 100 can prepare a natural product for use as an ingredient of at least one of a food product, a beverage, animal feed, or as a nutrient for a microbial culture. The system 100 can be a system for preparing a natural product for biomanufacturing.

The system 100 can include a vessel 105 to include a natural product 110 including a concentration of an acid. The vessel 105 can be any suitable vessel for holding an acidic liquid. Nonlimiting examples of vessels include, but are not limited to, beakers, buckets, test tubes, drums, barrels, reservoirs, bottles, jars, tanks, silos, flasks, vats, and pitchers.

The natural product 110 can be a liquid, semi-liquid, or liquid with suspended solid. The natural product 110 can comprise a nutrient (e.g., carbohydrates, protein, amino acids, vitamins or other soluble nutrients or a combination of any two or more thereof. such as monosaccharides (glucose, galactose, fructose), disaccharides (sucrose, maltose, lactose) and polysaccharides (starches and glycogen)). For example, the natural product 110 can be a liquid comprising lactose. For example, the natural product 110 can be a liquid comprising glucose. For example, the natural product 110 can be a liquid comprising fructose. The natural product 110 can be a product (e.g., a dairy product) originating from an animal such as a cow, sheep, goat, buffalo, camel, yak, or a combination of any two or more thereof; a product (e.g., a juice or pulp) originating from a vegetable (e.g., carrot, celery, spinach, cucumber, beet, kale, pumpkin, sweet potato, lettuce, radish, pea, ginger, or a combination of any two or more thereof); a liquid product (e.g., a juice) originating from a fruit (e.g., orange, grape, apple, cranberry, tomato, pineapple, lemon, grapefruit, mango, pomegranate, kiwi, cherry, coconut, blackberry, acai, papaya, pear, or a combination of any two or more thereof); a product of a grain (e.g., wheat, barley, rye, oats, rice, corn, sorghum, millet, quinoa, buckwheat, amaranth, or a combination of any two or more thereof); a product from a nut (e.g., almond, cashew, walnut, pistachio, pecan, hazelnut, or a combination of any two or more thereof); or a combination of any two or more thereof. In any embodiment, the natural product 110 can be a dairy product or byproduct, including milk, milk permeate, whey, whey protein isolate, whey protein concentrate, milk retentate, buttermilk, whey permeate, demineralized whey, cheese, sour cream, cottage cheese, butter, yogurt, ice cream, cream, or a combination of any two or more thereof. In any embodiment, the natural product 110 can be grain product including a beer, a spent grain, a wort, brewery wastewater, or a combination of any two or more thereof.

The natural product 110 can be a liquid agricultural byproduct of an agricultural process. For example, the agricultural byproduct can be generated during the processing of crops, livestock, or dairy products. The agricultural byproduct can be a homogeneous liquid that includes a sugar (e.g., lactose, sucrose, glucose, galactose, fructose, maltose, or a combination of any two or more thereof). Nonlimiting examples of agricultural byproducts include milk permeate, whey (e.g., from cheese manufacturing), whey permeate, whey protein isolate, whey protein concentrate, milk retentate, buttermilk, demineralized whey, delactose permeate, crop residues, and glycerin.

Milk permeate can be a product of the production of milk protein concentration, milk protein isolate, or ultrafiltered milk manufacturing. Milk permeate can be derived directly from milk. An example composition of milk permeate is provided in Table 1.

TABLE 1
Example Milk Permeate Composition

| Component | Range (wt. %) |
|---|---|
| Protein (non-protein nitrogen) | 0.01-10 |
| Fat | 0-5 |
| Lactose | 50-95 |
| Ash | 5-20 |
| Moisture | 2-10 |
| Sodium | 0.3-1 |
| Calcium | 0.3-1 |
| Magnesium | 0.1-1 |
| Potassium | 1-5 |

Whey permeate can be a coproduct of the production of whey protein concentrate and whey protein isolate. It has good solubility and a pleasant dairy flavor. An example composition of whey permeate is provided in Table 2.

TABLE 2
Example Whey Permeate Composition

| Component | Range (wt. %) |
|---|---|
| Protein (non-protein nitrogen) | 0.1-10 |
| Fat | 0-2 |
| Lactose | 50-90 |
| Ash | 0.1-30 |
| Moisture | 2-10 |
| Sodium | 0.3-5 |
| Calcium | 0.3-5 |
| Magnesium | 0.1-10 |
| Potassium | 1-5 |

Demineralized whey (also called reduced-minerals whey) is obtained by removing a portion of the minerals from pasteurized whey. Typical levels of demineralization are 25%-90%. Demineralized whey is produced by physical separation techniques such as precipitation, filtration, or dialysis. An example composition of demineralized whey is provided in Table 3.

TABLE 3
Example Demineralized Whey Composition

| Component | Range (wt. %) |
|---|---|
| Protein (non-protein nitrogen) | 10-20 |
| Fat | 0-2 |
| Lactose | 50-90 |
| Ash | 1-10 |
| Moisture | 2-10 |

Delactosed permeate is the co-product generated during the separation of pre-crystallized lactose from milk permeate and/or whey permeates. An example composition of delactosed permeate is provided in Table 4.

TABLE 4
Example Delactosed Permeate Composition

| Component | Range (wt. %) |
|---|---|
| Protein (non-protein nitrogen) | 0.1-5 |
| Fat | 0-2 |
| Lactose | 2-20 |
| Ash | 0.5-20 |
| Sodium | 0.01-2 |
| Calcium | 0.01-2 |
| Magnesium | 0.001-2 |
| Potassium | 0.1-5 |

The acid can include a food-grade acid or an industrial-grade acid. For example, the acid can be phosphoric acid, sulfuric acid, hydrochloric acid, acetic acid, citric acid, tartaric acid, metatartaric acid, fumaric acid, malic acid, lactic acid, or a combination of any two or more thereof. For example, the acid can be phosphoric acid.

The concentration of the acid is a concentration that can decrease the pH of the agricultural product to the first pH. The concentration of the acid can depend on the type of agricultural product and the type of acid. For example, the concentration of the acid can be 0.5 wt. % to about 30 wt. % of the total weight of the mixture (e.g., 0.5 wt. %, 1 wt. %, 2 wt. %, 3 wt. %, 4 wt. %, 5 wt. %, 10 wt. %, 20 wt. %, or 30 wt. %). For example, the concentration of the acid can be 0.5 wt. % to about 10 wt. %.

The system 100 can include a first sensor 115 to determine the natural product 110 that includes the concentration of the acid has a first pH. The first pH can range from 0 to 3 (e.g., 0, 0.5, 1, 1.5, 2, 2.5, or 3). For example, the first pH can range from 1.5 to 2.5.

The first sensor 115 can detect or determine the pH of the natural product 110. For example, the first sensor 115 can be a pH sensor. For example, the pH sensor can be a glass electrode pH sensor that includes a glass electrode that generates a voltage that corresponds to the pH level when the glass electrode is immersed in the natural product. For example, the pH sensor can be an ion-selective field effect transistor (ISFET) pH sensor that includes field effect transistor (FET) with an ion-selective gate as a sensing element. For example, the pH sensor can be an optical pH sensor that detects pH changes based on optical properties. For example, the pH sensor can be a solid-state pH sensor that includes a solid-state material that interacts with hydrogen ions to create an electrical signal. For example, the first sensor 115 can be a conductivity meter, where the change in conductivity is used to determine the pH. For example, the first sensor 115 can be a pH test paper strip that is contacted with the natural product to determine pH of the natural product based on a color change of the pH test paper strip. For example, the first sensor 115 can be a pH indicator solution added to at least a portion of the natural product to determine pH based on a color change of the indicator in the natural product solution.

The natural product 110 can be stable at the first pH for 1 hour to 35 years (e.g., 2 hours, 12 hours, 1 day, 14 days, 1 month, 6 months, 1 year, 5 years, 10 years, 20 years, or 30 years). As an example, during the period of stability, the agricultural product 110 can be transported from the processing location to an end use location. As another example, during the period of stability, the agricultural product 110 can be stored until ready for sale or use.

The system 100 can include a fluid transfer tool 130 to add a base 135 to the natural product 110 that includes the concentration of the acid to form the modified natural product 125 that includes the concentration of the acid and the concentration of the base.

The fluid transfer tool 130 can be any suitable fluid transfer tool to controllably transport the base 135 into the natural product 110. Nonlimiting examples of a fluid transfer tool 130 include a tube, vessel, dispenser, syringe, dropper, pipette, funnel, spout, burette, graduated cylinder, pump dispenser, or siphon system. The transfer tool 130 can be operated manually or automatically.

The base 135 can be a food-grade or industrial-grade base. For example, the base can include ammonium hydroxide, sodium hydroxide, potassium hydroxide, calcium hydroxide, sodium bicarbonate, sodium carbonate, calcium oxide, calcium carbonate, potassium bicarbonate, potassium carbonate, sodium pyrophosphate tetrabasic, sodium potassium tripolyphosphate, sodium potassium tartrate, sodium phosphate, magnesium oxide, magnesium hydroxide, magnesium carbonate, ammonium carbonate, or a combination of any two or more thereof. For example, the base 135 can include ammonium hydroxide.

The concentration of the base 135 is a concentration that can increase the pH of the agricultural product to the second pH. The concentration of the base can depend on the type of agricultural product, the first pH, and the type of base. For example, the concentration of the base can be 50 mM to about 1 M (e.g., 50 mM, 60 mM, 70 mM, 80 mM, 90 mM, 100 mM, 150 mM, 200 mM, 300 mM, 400 mM, 500 mM, 600 mM, 700 mM, 800 mM, 900 mM, or 1 M). For example, the concentration of the base can be 70 mM to about 100 mM.

The system 100 can include at least one of the first sensor 115 or a second sensor 140 to determine the natural product that includes the concentration of the acid and that includes the concentration of the base has a second pH within a range of 4 to 9 (e.g., 4, 4.5, 5, 5.5, 6, 6.5, 7, 7.5, 8, 8.5, or 9). For example, the second pH can range from 4.5 to 6.5.

The second sensor 140 can detect or determine the pH of the natural product 110. For example, the second sensor 140 can be a pH sensor. For example, the pH sensor can be a glass electrode pH sensor, an ion-selective field effect transistor (ISFET) pH sensor, an optical pH sensor, or a solid-state pH sensor. For example, the second sensor 140 can be a conductivity meter, where the change in conductivity is used to determine the pH. For example, the second sensor 140 can be a pH test paper strip that is contacted with the natural product to determine pH of the natural product based on a color change of the pH test paper strip. For example, the second sensor 140 can be a pH indicator solution added to at least a portion of the natural product to determine pH based on a color change of the indicator in the natural product solution.

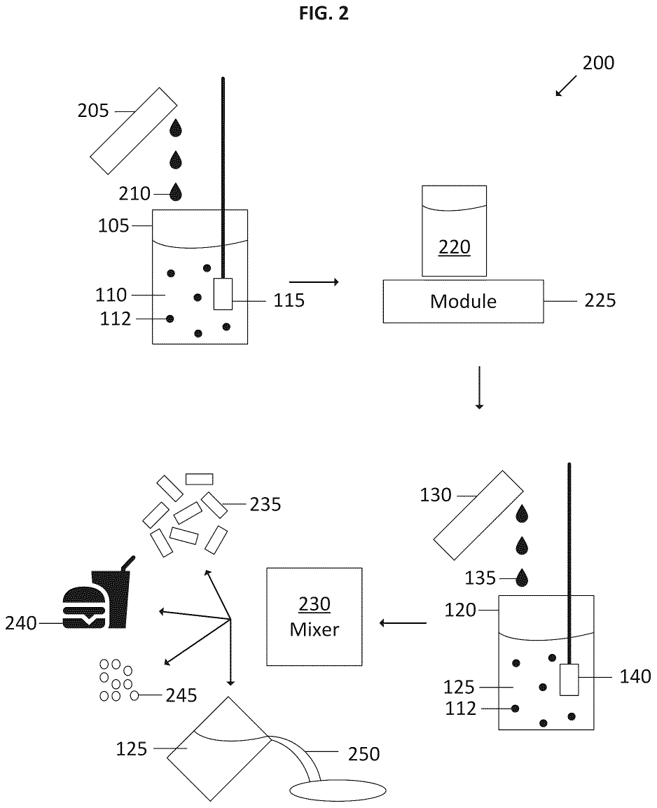

FIG. 2, among others, depicts another example illustration of a system 200. The system 200 can be a system for preparing a natural product. The system 200 can modify the natural product. The system 200 can prepare natural products to reduce or prevent susceptibility to spoilage, thereby extending the shelf life of the agricultural products. The system 200 can chemically treat the natural products to form modified natural products. The modified natural products can be sterilized forms of the natural products. The system 200 can prepare a natural product for use as an ingredient of at least one of a food product, a beverage, animal feed, or as a nutrient for a microbial culture. The system 200 can be a system for preparing a natural product for biomanufacturing.

The system 200 can include a vessel 105 to include the natural product 110, as described herein. The system 200 can include the natural product 110, as described herein. The system 200 can include the first sensor 115, as described herein. The system 200 can include the vessel 120, the modified natural product 125, the second fluid transfer tool 130, the base 135, and the second sensor 140, as described herein. The vessel 120 can be the same or different than the vessel 105. The first sensor 115 can be the same or different than the second sensor 140. The first fluid transfer tool 205 can be the same or different than the second fluid transfer tool 130.

The natural product 110 can include a solid 112 dispersed or suspended in the natural product 110. The solid 112 can be a solid particulate. The solid particulate can be dispersed in the natural product 110. The solid particulate can be suspended in the natural product 110. The solid 112 can be a solid natural product. The natural product 110 can include a slurry with the solid 112 in it. The natural product 110 can include the solid 112 in an amount of about 1 wt. % to about 90 wt. % relative to the total weight of the natural product 110 (e.g., about 1 wt. % to about 50 wt. %, about 5 wt. % to about 20 wt. %, or about 1 wt. % to about 10 wt. %). The natural product 110 can be mostly the solid 112 (e.g., greater than 80 wt. %). The natural product 110 can be majority solid 112 (e.g., greater than 50 wt. %). For example, the natural product 110 can include a byproduct from the brewing industry. The brewery byproduct can be a brewery's spent grain, which is a moist non-homogenous product. The amount of solid in the spent grain byproduct can be decreased by concentrating the spent grain less (i.e., having more water in the solution). As another example, the natural product 110 can include a solid product from the dairy industry. Nonlimiting examples of the solid product can include milk solids, milk curds, and protein particulates.

The system 200 can include a first fluid transfer tool 205 to add the acid 210 to the natural product 110 to form the sterilized natural product 220 that includes the concentration of the acid at the first pH. Once the first fluid transfer tool 205 adds the acid 210 to the natural product 110, the sterilized natural product 220 that includes the concentration of the acid can be stored for 1 hour to 35 years (e.g., about 1 hour to about 10 years, about 1 day to about 10 years, or about 1 month to about 1 year) at the first pH, at a temperature of about 4° C. to about 40° C. (e.g., about 15° C. to about 35° C.), and at a pressure of about 0.001 atm to about 1.5 atm (e.g., about 08 atm to about 1.2 atm).

The first fluid transfer tool 205 can be any suitable fluid transfer tool to controllably transport the acid 210 into the natural product 110. Nonlimiting examples of the first fluid transfer tool 205 include a tube, vessel, dispenser, syringe, dropper, pipette, funnel, spout, burette, graduated cylinder, pump dispenser, or siphon system. The first fluid transfer tool 205 can be operated manually or automatically.

The acid 210 can be a food-grade acid or an industrial-grade acid. For example, the acid can include phosphoric acid, sulfuric acid, hydrochloric acid, acetic acid, citric acid, tartaric acid, metatartaric acid, fumaric acid, malic acid, lactic acid, or a combination of any two or more thereof. For example, the acid 210 can be phosphoric acid.

The system 200 can include a module 225 for storing and/or transporting the sterilized natural product 220. The module 225 can store the sterilized natural product 220 for 1 hour to 35 years (e.g., about 1 hour to about 10 years, about 1 day to about 10 years, or about 1 month to about 1 year) at the first pH, at a temperature of about 4° C. to about 40° C. (e.g., about 15° C. to about 35° C.), and at a pressure of about 0.001 atm to about 1.5 atm (e.g., about 08 atm to about 1.2 atm).

The module 225 can be for storing the sterilized natural product 220, transporting the sterilized natural product 220, or a combination thereof. Nonlimiting examples of the module 225 include a rack, pallet, tote, bin, tray, box, crate, container, or silo.

The system 200 can include a mixer 230. The mixer 230 can be a mixer for mixing the modified natural product 125 to prepare at least one of a food product, a beverage, animal feed, or as a nutrient for a microbial culture. The mixer 230 can be a mixer for preparing the modified natural product 125 for use as an ingredient in at least one of a food product, a beverage, animal feed, or as a nutrient for a microbial culture.

The mixer 230 can be any suitable mixer for preparing the modified natural product 125 for use. Nonlimiting examples of the mixer 230 include a planetary mixer, vertical mixer, ribbon blender, paddle mixer, rotor-stator mixer, colloid mixer, spiral mixer, emulsifier, kneader, homogenizer, or mixing tank. The mixer 230 can include a grinder, slicer, dehydrator, oven, cooker, and packaging and sealing equipment.

The mixer 230 can produce an animal feed 235, a food or beverage product 240, or a nutrient 245 for a microbial culture that includes the modified natural product 125. The mixer 230 can produce an ingredient for an animal feed 235, a food or beverage product 240, or a nutrient 245 for a microbial culture that includes the modified natural product 125. In additional or alternate embodiments, the mixer 230 can produce a treated waste environmental discharge 255 that includes the modified natural product 125.

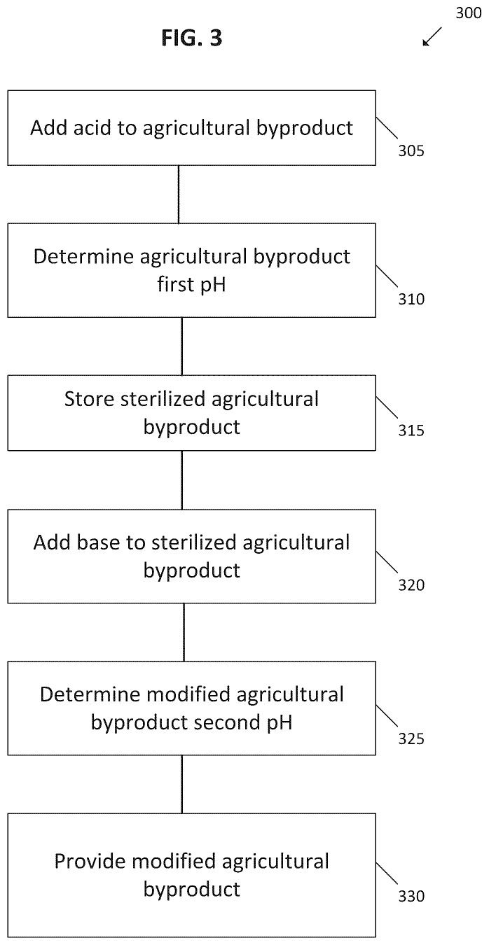

FIG. 3, among others, depicts a flow diagram of an example method 300 of preparing a natural product. The method 300 can modify the natural product. The method 300 can prepare agricultural products to reduce or prevent susceptibility to spoilage, thereby extending the shelf life of the agricultural products. The method 300 can chemically treat the natural products to form modified natural products. The modified natural products can be sterilized forms of the natural products. The method 300 can prepare a natural product for use as an ingredient of at least one of a food product, a beverage, animal feed, or as a nutrient for a microbial culture. The method 300 can be a method for preparing a natural product for biomanufacturing.

The method 300 can include step 305. Step 305 is adding the acid to the natural product. The natural product can be a liquid byproduct of an agricultural process. For example, the natural product can be generated during the processing of crops, livestock, or dairy products. The natural product can be a homogeneous liquid that includes a nutrient (e.g., carbohydrates, protein, amino acids, vitamins or other soluble nutrients or a combination of any two or more thereof, such as monosaccharides (glucose and fructose), disaccharides (maltose and lactose) and polysaccharides (starches and glycogen)). Nonlimiting examples of natural products include milk permeate, whey, whey permeate, crop residues, and glycerin. Nonlimiting examples of modified natural products include sterilized milk permeate, sterilized whey, sterilized whey permeate, sterilized crop residue, and sterilized glycerin. The natural product can be disposed in a vessel, as disclosed herein.

The acid can be a food-grade acid or an industrial-grade acid. For example, the acid can include phosphoric acid, sulfuric acid, hydrochloric acid, acetic acid, citric acid, tartaric acid, metatartaric acid, fumaric acid, malic acid, lactic acid, or a combination of any two or more thereof. For example, the acid can be phosphoric acid.

The concentration of the acid is a concentration that can decrease the pH of the agricultural product to the first pH. The concentration of the acid can depend on the type of agricultural product and the type of acid. For example, the concentration of the acid can be 0.5 wt. % to about 30 wt. % (e.g., 0.5 wt. %, 1 wt. %, 2 wt. %, 3 wt. %, 4 wt. %, 5 wt. %, 10 wt. %, 20 wt. %, or 30 wt. %). For example, the concentration of the acid can be 0.5 wt. % to about 10 wt. %.

The method 300 can include step 310. Step 310 is determining the first pH of the modified natural product. Determining the first pH of the modified natural product can include detecting the pH of the modified natural product. The first pH can range from 0 to 3 (e.g., 0, 0.5, 1, 1.5, 2, 2.5, or 3). For example, the first pH can range from 1.5 to 2.5.

Steps 305 and 310 can include adding the acid portionwise to the natural product while detecting the first pH of the natural product with a first sensor until the natural product reaches the first pH.

The first sensor can detect the first pH of the natural product. For example, the first sensor can be a pH sensor. For example, the pH sensor can be a glass electrode pH sensor, an ion-selective field effect transistor (ISFET) pH sensor, an optical pH sensor, a solid-state pH sensor. The first sensor can be a conductivity meter. The first sensor can be a pH test paper strip or a pH indicator solution.

The method 300 can include step 315. Step 315 is storing and/or transporting the modified natural product. Step 315 can include storing and/or transporting the modified natural product at the first pH. The modified natural product can be stored and/or transported for 1 hour to 35 years (e.g., about 1 hour to about 10 years, about 1 day to about 10 years, or about 1 month to about 1 year) at the first pH, at a temperature of about 0° C. to about 50° C. (e.g., about 4° C. to about 40° C., about 15° C. to about 35° C.), and at a pressure of about 0.001 atm to about 1.5 atm (e.g., about 08 atm to about 1.2 atm). The modified natural product can be transported from the manufacturing location to a storage location, from the manufacturing location to the end-use location, or from the storage location to the end-use location.

The method 300 can include step 320. Step 320 is adding abase to the modified natural product. Step 320 can include adding a concentration of the base to the modified natural product that includes the concentration of the acid to form a further modified natural product. The further modified natural product can be a modified sterilized natural product at a second pH appropriate for an end use.

The base can be a food-grade or industrial-grade base. For example, the base can include ammonium hydroxide, sodium hydroxide, potassium hydroxide, calcium hydroxide, sodium bicarbonate, sodium carbonate, calcium oxide, calcium carbonate, potassium bicarbonate, potassium carbonate, sodium pyrophosphate tetrabasic, sodium potassium tripolyphosphate, sodium potassium tartrate, sodium phosphate, magnesium oxide, magnesium hydroxide, magnesium carbonate, ammonium carbonate, or a combination of any two or more thereof. For example, the base can be ammonium hydroxide.

The concentration of the base is a concentration that can increase the pH of the agricultural product to the second pH. The concentration of the base can depend on the type of agricultural product, the first pH, and the type of base. For example, the concentration of the base can be 50 mM to about 1 M (e.g., 50 mM, 60 mM, 70 mM, 80 mM, 90 mM, 100 mM, 150 mM, 200 mM, 300 mM, 400 mM, 500 mM, 600 mM, 700 mM, 800 mM, 900 mM, or 1 M). For example, the concentration of the base can be 70 mM to about 100 mM.

The method 300 can include step 325. Step 325 is determining the second pH of the modified natural product. Determining the second pH of the modified natural product can include detecting the second pH of the modified natural product. The second pH can range from 4 to 9 (e.g., 4, 4.5, 5, 5.5, 6, 6.5, 7, 7.5, 8, 8.5, or 9). For example, the second pH can range from 4.5 to 6.5.

Steps 320 and 325 can include adding the base portionwise to the natural product while detecting the second pH of the natural product with the first sensor or a second sensor until the natural product reaches the second pH.

The first sensor or a second sensor can detect the second pH of the natural product. For example, the second, sensor can be a pH sensor, as described herein. The second sensor can be a conductivity meter. The second sensor can be a pH test paper strip or a pH indicator solution.

The method 300 can include step 330. Step 330 is providing the modified natural product. Providing the modified natural product can include providing the modified natural product for a use. Providing the modified natural product can include providing the modified sterilized milk permeate as an ingredient of at least one of a food product, a beverage, animal feed, or as a nutrient for a microbial culture. Providing for use can include providing the modified natural product for additional processing, such as mixing, cooking, fermenting, drying, freezing, emulsifying, fortifying, or similar processes. Providing the modified natural product can include producing a treated waste environmental discharge that includes the modified natural product.

In any embodiment, the method 300 can include additional steps. Additional steps can include the incorporation of stabilizing agents, nutrients, or functional additives during or after pH adjustment.

The systems and methods disclosed herein can also be integrated into existing processing lines to increase efficiency and scalability. For example, the systems and methods disclosed herein can include automated control systems with integrated sensors for real-time monitoring and adjustment of pH levels, providing consistent and precise treatment across batches.

The systems and methods disclosed herein can also include monitoring and optimization steps with monitoring and optimization equipment. These monitoring and optimization steps can be specifically aimed at increasing precision and control over parameters such as pH levels, additives, and other chemical variables. For example, the systems and methods can include real-time monitoring systems that continuously measure and adjust parameters like pH, temperature, and concentration of the natural product 110 during the method 300. The system can include sensors and feedback mechanisms to make real-time adjustments, ensuring that the predetermined conditions are maintained consistently throughout the process. Additionally, combinations of additives, acids, and bases can be precisely introduced based on sensor feedback, optimizing reaction outcomes and improving overall process efficiency.

Also disclosed herein are modified natural products. The modified natural product can be a preserved natural product. The preserved natural product can be the natural product treated according to the method 300. The modified natural product can include a salt. The salt can be an aqueous salt formed by the method 300. Specifically, the salt can be formed by adding the acid and adding the base to the natural product. The salt can include ammonium phosphate, sodium phosphate, potassium phosphate, calcium phosphate, magnesium phosphate, ammonium sulfate, sodium sulfate, potassium sulfate, calcium sulfate, magnesium sulfate, ammonium chloride, sodium chloride, potassium chloride, calcium chloride, magnesium chloride, ammonium acetate, sodium acetate, potassium acetate, calcium acetate, magnesium acetate, ammonium citrate, sodium citrate, potassium citrate, calcium citrate, magnesium citrate, ammonium tartrate, sodium tartrate, potassium bitartrate, calcium tartrate, magnesium tartrate, ammonium fumarate, sodium fumarate, potassium fumarate, calcium fumarate, magnesium fumarate, ammonium malate, sodium malate, potassium malate, calcium malate, magnesium malate, ammonium lactate, sodium lactate, potassium lactate, calcium lactate, magnesium lactate, or a combination of any two or more thereof. For example, the salt can be ammonium phosphate. The salt can stabilize and/or enrich the natural product as an ingredient of at least one of a food product, a beverage, animal feed, or as a nutrient for a microbial culture (e.g., for biomanufacturing).

The concentration of the salt in the natural product can be 100 mM to about 2 M (e.g., 100 mM, 120 mM, 140 mM, 160 mM, 180 mM, 200 mM, 300 mM, 400 mM, 600 mM, 800 mM, 1 M, 1.2 M, 1.4 M, 1.6 M, 1.8 M, or 2 M). For example, the concentration of the salt can be 70 mM to about 200 mM.

As an example, the natural product can be milk permeate and the salt can be aqueous ammonium phosphate. The aqueous ammonium phosphate can include monoammonium phosphate, diammonium phosphate, ammonium dihydrogen phosphate, or a combination of any two or more thereof. For example, the concentration of aqueous ammonium phosphate in the milk permeate can include 1 mM to 100 mM monoammonium phosphate and 1 mM to 100 mM diammonium phosphate. For example, the concentration of aqueous ammonium phosphate in the milk permeate can include 5 mM to 45 mM monoammonium phosphate and 35 mM to 80 mM diammonium phosphate, or 10 mM to 20 mM monoammonium phosphate and 60 mM to 80 mM diammonium phosphate.

As an example, a sample of milk permeate was stored for four months at 4° C., during which time the milk permeate developed many bacteria and flocculants and had a pH of 6.82. To treat the bacteria-laden milk permeate, an amount of an 85 wt. % phosphoric acid solution was added to a portion of the milk permeate to reduce the pH of the milk permeate to 2, where the amount of phosphoric acid in the milk permeate was 0.6 wt. %. To check for bacterial growth, the treated milk permeate was diluted 0-fold, 10-fold, 100-fold, and 1000-fold, and plated on LB agar plates. After 24 hours of incubation at 37° C., none of the treated milk permeate samples on agar plates visually appeared to have bacterial growth. In comparison, untreated bacteria-laden milk permeate diluted and plated in the same manner visually appeared to have a large amount of bacterial colony growth. Under the 1000-fold dilution conditions, the untreated milk permeate had 1154 bacterial colonies. These results indicate that the phosphoric acid treatment at 0.6 wt. % can efficiently kill bacteria in milk permeate.

As another example, milk permeate was treated with phosphoric acid to a concentration of 0.5 wt. % and a pH of 2.16. Samples of the treated milk permeate were stored at a temperature of 20° C. to 25° C. for 1 hour, 3 hours, 9 hours, or 48 hours. The samples were then centrifuged at 8000 g for 2 minutes and the cells therefrom were resuspended in M9 (no carbon) media. The resuspended cells were directly plated on LB agar plates at 100 μL per plate and cultured at 37° C. for 24 hours, after which bacterial colony numbers were quantified. None of the samples had bacterial colonies after 24 hours of incubation, indicating that treatment with 0.5 wt. % phosphoric acid for as little as 1 hour is sufficient to destroy bacteria.

As another example, milk permeate was treated with different concentrations of phosphoric acid and different pH values according to Table 5. Milk permeate samples treated with phosphoric acid according to Table 5 were left at a temperature of 20° C. to 25° C. for 72 hours The samples were then centrifuged at 8000 g for 2 minutes and the cells therefrom were resuspended in M9 (no carbon) media. This step helps neutralize the acid from the acid treatment step so that it does not interfere with bacterial growth in later steps. The resuspended cells were directly plated on LB agar plates at 100 μL per plate and cultured at 37° C. for 24 hours, after which bacterial colony numbers were quantified. Results indicated that sample 1 with 0 wt. %, used as a control, showed a law of bacteria. Sample 2 had thousands of bacterial colonies. Sample 3 had hundreds of bacterial colonies. Samples 4 and 5 had no bacterial colonies. The results indicate that phosphoric acid treatment of milk permeate at concentrations of 0.5 wt. % for 72 hours destroyed 100% of bacteria in the milk permeate.

TABLE 5
pH of milk permeate treated with phosphoric acid.

| Sample | Concentration | Milk Permeate |
|---|---|---|
| No. | Phosphoric Acid (wt. %) | pH |
| 1 | 0 | 6.74 |
| 2 | 0.1 | 4.62 |
| 3 | 0.2 | 3.40 |
| 4 | 0.5 | 2.16 |
| 5 | 0.6 | 2.00 |

As another example, milk permeate was treated by the method 300 and then used for downstream biomanufacturing. In particular, the milk permeate was treated with phosphoric acid to a concentration of 0.5 wt. % and a pH of 2.16. The milk permeate was stored at pH 2.16 for 1 hour, forming a sterilized milk permeate. Ammonium hydroxide was then added to the sterilized milk permeate to increase the pH of the milk permeate to 6.18, forming the treated milk permeate. Separately, a seed culture was prepared by inoculating WT E. coli Nissle 1917 carrying pTrc99a-EYIB (ECN-EYIB) bacteria with the antibiotic carbenicillin (car100) in lysogeny broth (LB) media. Here, EYIB refers to the gene cluster for beta-carotene biosynthesis, includes CrtE (GGPP synthase), CrtB (phytoene synthase), CrtI (phytoene desaturase), and CrtY (lycopene cyclase). Inoculated bacteria were cultured for about 12 hours at 37° C. The cultured bacterial cells were collected by centrifuging at 8000 g for 2 minutes, removing the supernatant, and re-suspending the cells in 100 μL of M9 (no carbon) media. Optical density at 600 nm (OD₆₀₀) of the resuspended cells was measured to determine biomass. Cells were cultured in three different sample media prepared in triplicate in 14 mL tubes. Sample 1 was a control including M9 media, NH₄Cl (1 g/L), and glucose (5 g/L); sample 2 was 50% M9 (without carbon or nitrogen sources) and 50% treated milk permeate; and sample 3 was treated milk permeate. Cells were cultured in the sample media for 24 hours at 37° C. Optical density, OD₆₀₀ and optical density at 453 (OD₄₅₃), were measured before and after 24 hours of culture. OD₄₅₃ was measured to determine β-Carotene production. Optical density results are shown in Table 6. Before culturing, sample 1 had an average OD₆₀₀ of 0.11; sample 2 had an average OD₆₀₀ of 0.12; and sample 3 had an average OD₆₀₀ of 0.115. After 24 hours of culture, the samples were diluted 10-fold and OD₆₀₀ and OD₄₅₃ were characterized, as shown in Table 6. The cell cultures of samples 1, 2, and 3 were pelleted and the color of the pellets was observed to determine β-carotene production. Results indicated that TMP media alone had slightly decreased cell growth as compared to the other sample conditions, but higher β-carotene production based on the β-carotene/biomass ratio. The sample 2 pellet also showed a darker color than the other conditions, indicating higher β-carotene production.

TABLE 6
Results of ECN-EYIB culture in different sample media in 14 mL tubes

| | | | | OD₄₅₃/OD₆₀₀ | OD₆₀₀ | OD₄₅₃ | OD₄₅₃/OD₆₀₀ |
|---|---|---|---|---|---|---|---|
| Sample | | OD₆₀₀ | OD₄₅₃ | ratio | Average | Average | ratio |
| M9 | S1-1 | 0.27 | 0.40 | 1.47 | 0.23 | 0.34 | 1.51 |
| | S1-2 | 0.21 | 0.32 | 1.57 | | | |
| | S1-3 | 0.21 | 0.30 | 1.48 | | | |
| 50% | S2-1 | 0.26 | 0.39 | 1.49 | 0.23 | 0.34 | 1.52 |
| TMP | S2-2 | 0.20 | 0.31 | 1.58 | | | |
| | S2-3 | 0.22 | 0.33 | 1.50 | | | |
| TMP | S3-1 | 0.18 | 0.25 | 1.40 | 0.17 | 0.26 | 1.56 |
| | S3-2 | 0.18 | 0.28 | 1.57 | | | |
| | S3-3 | 0.15 | 0.26 | 1.70 | | | |

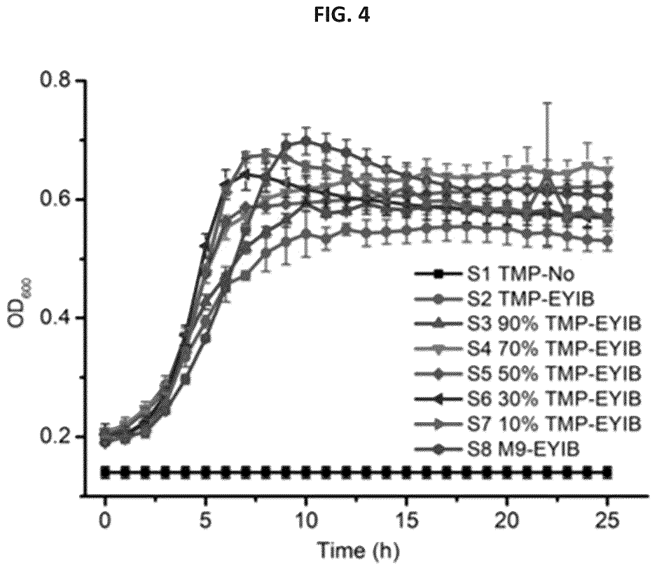

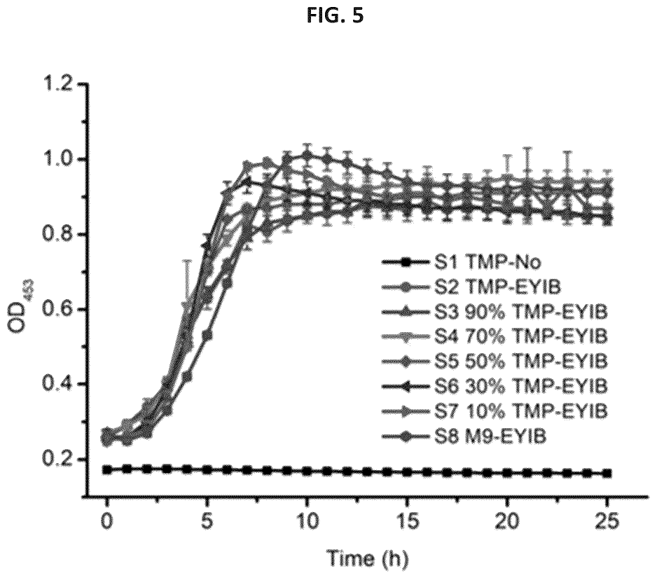

As another example, milk permeate was treated by the method 300 and then used for downstream biomanufacturing. In particular, the milk permeate was treated with phosphoric acid to a concentration of 0.5 wt. % and a pH of 2.16. The milk permeate was stored at pH 2.16 for 1 hour, forming a sterilized milk permeate. Ammonium hydroxide was then added to the sterilized milk permeate to increase the pH of the milk permeate to 6.18, forming the treated milk permeate. Separately, a seed culture was prepared by inoculating WT E. coli Nissle 1917 carrying pTrc99a-EYIB (ECN-EYIB) bacteria with the antibiotic carbenicillin (car100) in lysogeny broth (LB) media. Inoculated bacteria were cultured for about 12 hours at 37° C. The cultured bacterial cells were collected by centrifuging at 8000 g for 2 minutes, removing the supernatant, and re-suspending the cells in 100 μL of M9 (no carbon) media. Cells were cultured in a 24-well plate, including 8 different samples prepared in triplicate. Sample 1 (S1) was treated milk permeate without bacteria as a negative control; sample 2 (S2) was treated milk permeate with ECN-EYIB; sample 3 (S3) was 90% treated milk permeate and 10% M9 media with ECN-EYIB; sample 4 (S4) was 70% treated milk permeate and 30% M9 media with ECN-EYIB; sample 5 (S5) was 50% treated milk permeate and 50% M9 media with ECN-EYIB; sample 6 (S6) 30% treated milk permeate and 70% M9 media with ECN-EYIB; sample 7 (S7) was 10% treated milk permeate and 90% M9 media with ECN-EYIB; and sample 8 (S8) was M9 media with ECN-EYIB. The samples were cultured for 24 hours at 37° C., with OD₆₀₀ and OD₄₅₃ characterized every hour in a plate reader 15 minutes after shaking. Results are shown in FIGS. 4 and 5. FIG. 4 is a graph of average OD₆₀₀ and FIG. 5 is a graph of average OD₄₅₃. Maximum OD₆₀₀ results over the 24 hour period were S2, 0.55; S3, 0.59; S4, 0.64; S5, 0.61; S6, 0.6; S7, 0.64; and S8, 0.68. Final OD₆₀₀ results after 24 hours of culture were S2, 0.53; S3, 0.57; S4, 0.65; S5, 0.62; S6, 0.57; S7, 0.57; and S8, 0.61. Maximum OD₄₅₃ results over the 24 hour period were S2, 0.83; S3, 0.87; S4, 0.93; S5, 0.93; S6, 0.91; S7, 0.89; and S8, 0.93. Final OD₄₅₃ results after 24 hours of culture were S2, 0.80; S3, 0.85; S4, 0.94; S5, 0.92; S6, 0.85; S7, 0.87; and S8, 0.91. These results indicated that treated milk permeate can support bacterial growth similarly to M9 media. These results also indicated that treated milk permeate has a slight inhibitory effect on the biomass of bacteria when compared with M9 media. These results also indicated that media including 70% of treated milk permeate and 30% M9 media, behaved the same as M9 media in terms of both the biomass and the β-Carotene production.

The systems and methods disclosed herein are for sterilizing and preserving agricultural byproducts through chemical treatments that adjust pH levels. The process achieves significant microbial reduction and extends shelf life without the need for drying or traditional sterilization. The treated byproducts are stable for extended periods and suitable for use in food, beverages, animal feed, microbial cultures, and biomanufacturing. By forming beneficial salts, such as ammonium phosphate, the systems and methods can enhance the value of these materials for downstream applications, promoting sustainability and efficiency in industrial processes.

The systems and methods disclosed herein can be integrated into existing food processing infrastructure. The systems can include standardized connections and automated control systems for ease of integration. Standardized pipe sizes, valves, and fittings can ensure seamless integration. The systems and methods can be compatible with existing control systems for unified monitoring and data integration to provide real-time feedback. The systems and methods can operate alongside existing ones with little to no disruption. The systems and methods can provide integration smoothly and cost-effectively, enhancing the overall operation without compromising the functionality of the existing infrastructure.

The systems and methods disclosed herein can significantly increase energy efficiency compared to conventional methods by avoiding the use of energy-consuming conventional processes like pasteurization and drying. For example, the systems and methods may be free of any heating steps to sterilize the natural product.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example, the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to prepare a natural product, comprising:
a vessel to include a natural product including a concentration of an acid;
a first sensor to determine the natural product that includes the concentration of the acid has a first pH within a range of 0 to 3;
a fluid transfer tool to add a base to the natural product that includes the concentration of the acid; and
at least one of the first sensor or a second sensor to determine the natural product that includes the concentration of the acid and that includes the concentration of the base has a second pH within a range of 4 to 9.

2. The system of claim 1, comprising:
the fluid transfer tool to add the base to the natural product that includes the concentration of the acid after the natural product that includes the concentration of the acid has been stored for 1 hour to 35 years at the first pH and at a temperature of about 0° C. to about 50° C.

3. The system of claim 1, comprising:
the vessel to include the natural product including the concentration of the acid comprising phosphoric acid, sulfuric acid, hydrochloric acid, acetic acid, citric acid, tartaric acid, metatartaric acid, fumaric acid, malic acid, lactic acid, or a combination of any two or more thereof.

4. The system of claim 1, comprising:
the vessel to include the natural product including the concentration of the acid comprising phosphoric acid.

5. The system of claim 1, comprising:
the sensor to determine the natural product that includes the concentration of the acid has a first pH with the range of 1.5 to 2.5.

6. The system of claim 1, comprising:
the fluid transfer tool to add the base to the natural product that includes the concentration of the acid, the base comprising ammonium hydroxide, sodium hydroxide, potassium hydroxide, calcium hydroxide, sodium bicarbonate, sodium carbonate, calcium oxide, calcium carbonate, potassium bicarbonate, potassium carbonate, sodium pyrophosphate tetrabasic, sodium potassium tripolyphosphate, sodium potassium tartrate, sodium phosphate, magnesium oxide, magnesium hydroxide, magnesium carbonate, ammonium carbonate, or a combination of any two or more thereof.

7. The system of claim 1, comprising:
the fluid transfer tool to add the base to the natural product that includes the concentration of the acid, the base comprising ammonium hydroxide.

8. The system of claim 1, comprising:
a mixer to mix the natural product that includes the concentration of the acid and that includes the concentration of the base to prepare at least one of a food product, a beverage, animal feed, or as a nutrient for a microbial culture.

9. The system of claim 1, comprising:
at least one of the first sensor or the second sensor to determine the natural product that includes the concentration of the acid and that includes the concentration of the base has the second pH within a range of 4.5 to 6.5.

10. A method of preparing natural product, comprising:
adding an acid to a natural product to create a sterilized natural product;
determining that the sterilized natural product that includes the acid has a first pH within a range of 0 to 3;
adding a base to the sterilized natural product that includes the acid to create a modified sterilized natural product;
determining that the natural product that includes the acid and that includes the base has a second pH within a range of 4 to 9; and
providing the modified sterilized natural product as an ingredient of at least one of a food product, a beverage, animal feed, or as a nutrient for a microbial culture.

11. The method of claim 10, comprising:
storing the sterilized natural product that includes the acid for 1 hour to 35 years at the first pH prior to adding the base.

12. The method of claim 10, comprising:
adding the acid to the natural product to create the sterilized natural product, the acid comprising phosphoric acid, sulfuric acid, hydrochloric acid, acetic acid, citric acid, tartaric acid, metatartaric acid, fumaric acid, malic acid, lactic acid, or a combination of any two or more thereof.

13. The method of claim 10, comprising:
adding the acid to the natural product to create the sterilized natural product, the acid comprising phosphoric acid.

14. The method of claim 10, comprising:
determining that the sterilized natural product that includes the acid has a first pH within a range of 1.5 to 2.5.

15. The method of claim 10, comprising:
adding the base to the sterilized natural product that includes the acid to create the modified sterilized natural product, the base comprising ammonium hydroxide, sodium hydroxide, potassium hydroxide, calcium hydroxide, sodium bicarbonate, sodium carbonate, calcium oxide, calcium carbonate, potassium bicarbonate, potassium carbonate, sodium pyrophosphate tetrabasic, sodium potassium tripolyphosphate, sodium potassium tartrate, sodium phosphate, magnesium oxide, magnesium hydroxide, magnesium carbonate, ammonium carbonate, or a combination of any two or more thereof.

16. The method of claim 10, comprising:
adding the base to the sterilized natural product that includes the acid to create the modified sterilized natural product, the base comprising ammonium hydroxide.

17. The method of claim 10, comprising:
determining that the natural product that includes the acid and that includes the base has a second pH within a range of 4.5 to 6.5.

18. A modified sterilized natural product prepared by the method of claim 10.

19. A natural product comprising:
an aqueous salt comprising ammonium phosphate, calcium phosphate, sodium phosphate, or a combination of any two or more thereof.

20. The natural product of claim 18, comprising:
1 mM to 100 mM monoammonium phosphate; and
1 mM to 100 mM diammonium phosphate.
